(19) United States
(12) Patent Application Publication
(10) Pub. No.: US 2008/0256011 A1
(43) Pub. Date: Oct. 16, 2008

(54) Generalized reduced error logistic

(76) Inventor: Daniel M. Rice, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/904,542

(22) Filed: Sep. 27, 2007

Related U.S. Application Data
(60) Provisional application No. 60/887,278, filed on Jan. 30, 2007.

(51) Int. Cl. G06N 5/02

(52) U.S. Cl. 706/46

(57) ABSTRACT

The present disclosure is directed to a method for Generalized Reduced Error Logistic Regression (Generalized RELR). The method overcomes significant limitations in prior art logistic regression and non-generalized Reduced Error Logistic Regression (RELR) methods. The method is applicable to all current applications of logistic regression, but has significantly greater reliability and validity, using smaller sample sizes and large numbers of input variables, than prior art logistic regression methods. Further, unlike non-generalized RELR, the method of the present invention is not biased by the number of non-missing observations in independent variables. Rather, the method of the invention applies to repeated measures and multilevel designs. This Generalized RELR method also optimally scales solutions to achieve significantly greater accuracy than non-generalized RELR. This Generalized RELR method also automates variable selection to arrive at models with an optimal selection of variables. Variable selection features are not present in non-generalized RELR.

### REFERENCE TO RELATED APPLICATIONS

U.S. provisional patent application 60/887,278 filed Jan. 30, 2007.

### BACKGROUND OF THE INVENTION

This invention relates to a method of performing a logistic regression; and more particularly, a method requiring a substantially smaller sample size and allowing for more independent variables than standard logistic regression methods; but which provides roughly the same accuracy as these methods with large sample sizes and small numbers of independent variables. The problem related to small sample sizes and large numbers of independent variables is known as the multicollinearity problem, as logistic regression is especially inaccurate when there are a large number of collinear or correlated variables relative to the number of sample size observations. A well known 10:1 rule limits the number of independent variables to be 1/10 of the number of dependent variable target observations for reliable logistic regression (Peduzzi et al., 1996). This invention overcomes this 10:1 rule restriction. In addition to overcoming this multicollinearity problem, the method of the invention also overcomes two other major problems in logistic regression. These are the dimensionality and the IIA (“Independence from Irrelevant Alternatives”) problems.

Since the pioneering work of Luce (1959), there has been widespread use of logistic regression as an analytical engine to model decisions and outcomes. Examples of its application include predicting the probability that a person will get cancer given a list of their risk factors, predicting the probability that a person will vote Republican, Democratic or Green given their demographic profile, and predicting the probability that a high school student will rank in the bottom third, the middle third, or the upper third of their class given their socioeconomic and demographic profile. Logistic Regression has potential application to any scientific, engineering, social, medical, or business problem where dependent variable values can be formalized as binomial, multinomial, ranked-ordered, or interval-categorized outcomes. More generally, Logistic Regression is a machine learning method that can be programmed into robots and artificial intelligence agents for the same types of applications as Neural Networks, Random Forests, Support Vector Machines and other such machine learning methods, many of which are the subject of issued U.S. patents. Logistic Regression is an extremely important and widely used analytical method in today's economy. Unlike most other machine learning methods, Logistic Regression is not a “black box” method. Instead, Logistic Regression is a transparent method that does not require elaborate visualization methods to understand how a model works. Any substantial improvement in logistic regression that overcomes its limitations with regard to multicollinearity, dimensionality, and IIA problems will have significant impact in many applications.

The Logit, which is defined as the Log Odds of an outcome, is the important function that is ultimately estimated in Logistic Regression. Once one has the logit coefficients in this Logit function, it is straightforward to calculate related Utility functions. Luce and Suppes (1965) showed that the error on these Logit and Utility functions does not follow a Normal Gaussian error distribution, but instead follows the Extreme Value Type I distribution. McFadden (1974) confirmed that the Utility function has an error distribution that follows the Extreme Value Type I distribution. McFadden won the Nobel Prize in Economics in the year 2000 for this work.

As disclosed herein, applicant has developed a new method of logistic regression; i.e., Generalized Reduced Error Logistic Regression (“Generalized RELR”). Applicant presented some interesting theoretical results concerning a non-generalized precursor to this method and accompanying analytics at International Psychometric Society conferences in 2005 and 2006. A novel feature of applicant's method is that it incorporates symmetrical error constraints into the optimization that yields the Logit regression coefficients. Given these symmetrical error constraints, applicant has shown that the error distribution on the Logit from RELR can be described in terms of the Extreme Value Type I distribution that first became known to Luce and McFadden. Applicant showed that this error can be subtracted to result in a reduced error measure of the Logit and the Logit regression coefficients. Applicant further demonstrated that a RELR model built from a sample size of 100 could be as accurate as a standard logistic regression model built with a sample size at least in the range of 6,000 observations if all linear independent variables were present, but substantially more than 6,000 due to the number of nonlinear independent variables in the Rice (2006b) example model. A copy of applicant's manuscript that was distributed to Psychometric Society attendees, is referenced as Rice (2006b), and is attached hereto as Appendix 1. This manuscript sets forth the formulation presented to Psychometric Society members by applicant. The results show superior advantages of applicant's method at that time.

Nevertheless, the original non-generalized RELR, as presented in Appendix 1, had significant limitations. First, that method did not generalize to models in which independent variables have differing numbers of non-missing observations. This is because the relative size of a Logit coefficient is biased by the relative number of non-missing observations for each independent variable. Second, the originally disclosed method did not define the scale factor f) in relationship to the sum of variable importance as in this improved method. Instead, this scale factor f) was a fixed constant that did not reflect total variable importance. The proper definition of f) is critical to the proper general calculation of the logit coefficients. Third, the originally disclosed method did not generalize to designs where there are repeated measures or multilevel measures. For example, that originally disclosed method would not generally be able to give unbiased logit coefficient estimates for both individual and aggregate level independent variables in a design with repeated measures on individual level variables. Fourth, there was no understanding and mention of how the originally disclosed method in Appendix 1 would handle variable selection, whereas the present Generalized Reduced Error Logistic Regression Method has elaborate features that automatically produce variable importance ordering, variable importance screening, and variable selection. Variable selection processing is critical to the proper function of a Generalized RELR. Indeed, overcoming all of these limitations is critical to a Generalized Reduced Error Logistic Regression method that obtains generally reliable and valid logit coefficients. Applicant has recognized these limitations and has now invented a Generalized RELR method which overcomes them.

### BRIEF SUMMARY OF THE INVENTION

The present disclosure is directed to improvements in a method for Generalized Reduced Error Logistic Regression which overcomes significant limitations in prior art logistic regression and non-generalized RELR methods. The method of the present invention is applicable to all current applications of logistic regression, but it creates possibilities for entirely new applications. The present method effectively deals with the multicollinearity, dimensionality, and IIA problems, so it has significantly greater reliability and validity using smaller sample sizes and potentially very high dimensionality in numbers of input variables and does not need to assume IIA. These are major advantages over prior art logistic regression methods. Further, unlike the originally disclosed non-generalized RELR in Appendix 1, the method of the present invention is not biased by the number of non-missing observations in independent variables. Rather, the improved method of the invention allows repeated measures and multilevel designs. In addition, this improved method has elaborate variable selection methods and optimally scales the model with an appropriate scale factor f) that adjusts for total variable importance across variables to calculate reliable and valid logit coefficient parameters generally.

Multilevel and repeated measures are possible in standard maximum likelihood logistic regression, but like other applications of standard logistic regression, these models suffer from overfitting caused by multicollinearity error. This error can be dramatic with many variables in small sample sizes. Multilevel/repeated measures are also possible in a Bayesian form of logistic regression that is computed with a Markov Chain Monte Carlo (MCMC) approach (Allenby & Rossi, 1999) rather than the maximum likelihood approach used in standard logistic regression. The MCMC approach is also associated with a significant number of problems related to multicollinearity. For example, the MCMC approach will not even converge to a solution with serious multicollinearity (LeBlond, 2007). Even when it does converge to a solution, the MCMC approach can yield very unreliable Logit coefficients when multicollinearity is present, unless variables are averaged together to reduce multicollinearity error (Magidson, J., Eagle, T., & Vermunt, J. K., 2005).

The present invention overcomes multicollinearity problems in a maximum likelihood based logistic regression that does not have convergence problems. Since maximum entropy and maximum likelihood based logistic regression formulations yield identical solutions, the probability estimates that are computed with the present invention are consistent with the maximally non-committal Bayesian prior distribution associated with maximum entropy. While the MCMC approach also has a Bayesian interpretation, it requires a prior specification of the distribution of the Logit coefficients across individuals, such as a multivariate normal distribution (Allenby and Rossi, 1999). However, the distribution of the Logit coefficients across individuals is not known a priori. A multivariate normal distribution or another specified prior distribution is an assumption that can be completely incorrect. The maximum entropy approach of the present invention is equivalent to making no prior commitment about the form of this distribution and letting the data alone shape the posterior distribution. On the other hand, given that prior probabilities can easily be added to a maximum entropy formulation through the Kullback-Leibler extension of the maximum entropy method, the present invention is consistent with Bayesian prior probabilities should there be a reasonable necessity for them. However, logistic regression is most often employed without such prior Bayesian probabilities in its typical application.

The method of the present invention provides a very broad, new predictive modeling process that could completely replace standard logistic regression. This Generalized RELR method works in those problems where standard logistic regression does not and it converges to solutions that approximate those of standard logistic regression in low error problems where standard logistic regression works perfectly well. Generalized RELR can be used with binomial, multinomial, ranked, or interval-categorized dependent variables. Since continuous dependent variables always can be encoded as interval-categorized variables, it can be applied in practice to continuous variables after they are recoded, so its application extends into the continuous dependent variable realm of least-squares regression. Independent variables can be nominal, ordered, and/or continuous. Also, Generalized RELR works with independent variables that are interactions to whatever order is specified in the model. Generalized RELR works with multilevel and repeated measures designs, including individual level estimates. The process works with many independent variables, and also allows modeling of non-linear effects in independent variables up to the 4th order polynomial component. Generalized RELR handles the dimensionality problem relating to large numbers of variables by effectively prescreening variables to include only the most important variables in the logistic regression model. Generalized RELR also handles the IIA problem by substantially reducing the error that can lead to IIA problems and by allowing multiple choice sets with differing numbers of alternatives to be modeled either separately or simultaneously. Such a solution to the IIA problem is not practical with other logistic regression methods because of their requirement for large sample sizes to reduce error. RELR works very well with small sample sizes and this means that it is much easier to build multiple models corresponding to differing numbers of alternatives in choice sets.

The available data presented in this application suggest that Generalized RELR is significantly more accurate than all other predictive modeling methods tested in datasets involving small sample sizes and/or large numbers of informative variables. These comparison methods included Support Vector Machine, Neural Network, Decision Tree, Partial Least Squares and Standard Logistic Regression methods. Most of the results that are presented in the main body of this application will be presented to the SAS M2007 Conference on Oct. 1, 2007 at Caesar's Palace in Las Vegas, Nev. It will be the first partial public disclosure of this improved Generalized RELR, although many of the details presented herein about how to get a working Generalized RELR will not be disclosed and will be well guarded as trade secrets until a patent is issued. Other objects and features will be in part apparent and in part pointed out hereafter.

### DESCRIPTION OF THE DRAWINGS

In the accompanying drawings which form part of the specification:

FIG. 1 is a chart illustrating a split sample reliability of RELR in “small sample model”;

FIG. 2 is a chart illustrating a reliability of coefficients in reduced vs. fuller model;

FIG. 3 is a chart illustrating a variable selection in “small sample model”;

FIG. 4 is a chart illustrating a variable selection in “large sample model”;

FIG. 5 is a chart illustrating an accuracy comparison of “small sample model”;

FIG. 6 is a chart illustrating an accuracy comparison of “large sample model”;

FIG. 7 is a chart illustrating a variable selection in PTEN model;

FIG. 8 is a chart illustrating an accuracy comparison of PTEN model; and

FIG. 9 is a chart illustrating a simultaneously built vs. separately built models.

Corresponding reference numerals indicate corresponding parts throughout the several figures of the drawings.

### General Description of Invention

The manuscript of Appendix 1 provides a detailed formulation of the original non-generalized version of RELR. However, application of the method in Appendix 1 is specific to predictive problems with no multilevel specifications, no repeated measures, the exact same number of non-missing observations for each independent variable, no variable selection, nominally categorized dependent variables, and very large values of the total variable importance scale factor Ω. As such, its scope of application is limited to probably well less than 0.001% of all predictive modeling problems. The Rice (2005) presentation did offer a preliminary suggestion on how to deal with multilevel information based upon the Kullback-Leibler prior weights related to maximum entropy. These results were negative, so the originally disclosed non-generalized RELR had no effective multilevel capabilities.

The typical user of logistic regression is, for example, a research professional working in marketing research, education, social science research, medical research, data mining, engineering, and other areas of pure or applied research and science. This typical user is familiar with available computer software that implements complex logistic regression formulations. However, this user is probably not comfortable making changes to logistic regression formulations such as would be required to fix the originally non-generalized RELR so as to overcome its limitations. The limitations involving the biased coefficients due to differing number of non-missing observations and the variable importance scale factor Ω would be particularly problematic in usages involving even the most simple logistic regression models. A Generalized RELR process requires fixes to the method set forth in Appendix 1. Users of logistic regression might be comfortable changing inputs so they are ordered or interval-categorized dependent variables rather than nominal, but the present invention also treats ordered and interval-categorized dependent variables.

The present invention is a commercially viable Generalized Reduced Error Logistic Regression (“Generalized RELR”) that should have wide ranging applications in medicine, science, social science, artificial intelligence, and business. In actuality, we did not start using the term Reduced Error Logistic Regression to refer to the original non-generalized method until after the Rice (2006a, 2006b) presentation, but this name seems fitting for that original method and the greatly improved present generalized method. The same basic ideas that governed the non-generalized method in Appendix 1 govern the formulation that underlies Generalized RELR. That is, Generalized RELR is associated with a very large reduction in multicollinearity error that is normally observed in logistic regression with small sample sizes and large numbers of independent variables. As in the equations of Appendix 1, the equations of Generalized RELR are expressed in terms of choice theory such as yᵢⱼ=1 if the ith individual chooses the jth alternative, but this language is easily modified for non-choice applications of logistic regression such as in epidemiological, financial, genetics, weather, engineering, and geology etc., so that Generalized RELR has general application across logistic regression applications. In addition, the meaning of the word “individual” in its models can have a more aggregate meaning such as an individual retail location, an individual school, or an individual company's stock depending upon the application and the level at which the independent variable is measured.

### DETAILED DESCRIPTION OF INVENTION

The following description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

A Maximum Entropy Formulation

The present Generalized RELR method is based upon the maximum entropy subject to linear constraints formulation that Soofi (1992) showed to be equivalent to the Luce (1959) and McFadden (1974) maximum likelihood logit formulations and Golan et al. (1996) further developed to model error probabilities. In this formulation, we seek the maximum of the entropy function H(p,w):

$$H ( p , w ) = - {\sum }_{i = 1}^{N} {\sum }_{j = 1}^{C} {p}_{ij} ln ( {p}_{ij} ) - {\sum }_{l = 1}^{2} {\sum }_{r = 0}^{M} {\sum }_{j = 1}^{C} {w}_{ljr} ln ( {w}_{ljr} ) \qquad ( 1 )$$

subject to linear constraints that include:

$$\begin{matrix}{\sum }_{i = 1}^{N} {\sum }_{j = 1}^{C} ( {x}_{ijr} {y}_{ij} ) = {\sum }_{i = 1}^{N} [ {\sum }_{j = 1}^{C} ( {x}_{ijr} {p}_{ij} ) + {u}_{r} {w}_{1 jr} - {u}_{r} {w}_{2 jr} ] \\ for r = 1 to M . & ( 2 ) \\ {\sum }_{j = 1}^{C} {p}_{ij} = 1 for i = 1 to N & ( 3 ) \\ {\sum }_{j = 1}^{C} {w}_{jlr} = 1 for l = 1 to 2 and r = 1 to M & ( 4 ) \\ {\sum }_{i = 1}^{N} {\sum }_{j = 1}^{C} {y}_{ij} = {\sum }_{i = 1}^{N} {\sum }_{j = 1}^{C} {p}_{ij} for r = 0 , & ( 5 )\end{matrix}$$

where C is the number of choice alternatives, N is the number of observations and M is the number of data moment constraints. The constraint given as Equation (5) where r=0 is an intercept constraint. In the case of more than two alternatives C, the reference choice condition j=C should be chosen to reflect the multinomial category with the largest number of responses. This ensures that the t value described below is the most stable possible t value. This reference choice condition does not matter with only two alternatives.

In this formulation, yᵢⱼ=1 if the ith individual chooses the jth alternative from the choice set and 0 otherwise. Also, xᵢⱼᵣ is the rth characteristic or attribute associated with the ith individual who perceives the jth choice alternative, so xᵢⱼ is a vector of attributes specific to the jth alternative as perceived by the ith individual and xᵢ is a vector of characteristics of the ith individual. The pᵢⱼ term represents the probability that the ith individual chooses the jth alternative and wₗⱼᵣ represents the probability of error across individuals corresponding to the jth alternative and rth moment and lth sign condition. When l=1, wₗⱼᵣ represents the probability of positive error. When l=2, wₗⱼᵣ represents the probability of negative error.

The uᵣ term is a measure of the largest expected error for the rth moment. It is defined as:

$$\begin{matrix}{u}_{r} = Ω / ( {t}_{r} / \sqrt{{N}_{r}} ) for r = 1 to M . \\ where Ω is defined as \text{:} & ( 5 a ) \\ Ω = {\sum }_{r = 1}^{M} \vert {t}_{r} \vert / \sqrt{{N}_{r}} for r = 1 to M . & ( 5 b )\end{matrix}$$

The tᵣ value in Equation (5a) reflects the t value from a balanced one sample t-test that compares the mean difference between those non-missing values of xᵢᵣ in the reference choice condition, compared to non-missing values of xᵢᵣ in all other choice conditions. Nᵣ in Equations (5a) and (5b) reflects the number of non-missing values that go into the t value corresponding to the rth moment. The weighting by the inverse square root of Nᵣ ensures that Logit coefficients are not biased to have more or less weight simply as a function of the number of non-missing values in their corresponding moments. Ω is a positively valued scale factor that is the sum of the magnitude of the denominator of Equation (5a) across all r moments. If we take the magnitude of each tᵣ/\sqrt{Nᵣ}, to reflect the extent to which the rth moment is informative, then the sum of these magnitudes across all r moments to define Ω in Equation (5b) reflects the extent to which all moments are informative. Ω is the critical scale factor that determines how different this solution is from the standard maximum likelihood solution. As Ω approaches 0, the solution will approach the standard maximum likelihood solution. Extremely small values of Ω only occur when all moments have very small magnitude t values in relationship to very large sample sizes. On the other hand, extremely large values of Ω can only occur when all moments have very large magnitude t values in relationship to very small sample sizes. With a relatively large value of Ω, the solutions will be quite different from the standard maximum likelihood solutions.

The magnitude of uᵣ would only be large in those cases where the magnitude of tᵣ/\sqrt{Nᵣ} is small relative to the total value of Ω. One way to achieve this is when the magnitude of tᵣ is small in relation to this magnitude in the other moments, as in the case of a relatively non-informative moment. This is reasonable because cross product sums corresponding to small magnitude t values will have a greater expected error relative to cross product sums corresponding to large magnitude t values. A second way to achieve this would be if there were some moments with a large number of observations relative to other moments. This is only unreasonable if the sample size is too small to reflect a reliable t value in those moments with very small sample sizes. For this reason, a floor parameter needs to be in place to ensure that there are a minimum number of observations in each moment. We use a floor parameter of 60 in the examples reported below.

It will be noted that there are at least four distinct values of the observations that go into the one sample t value resulting from the product of the standardized variable xᵢᵣ and a weight of 1 or −1, even when the original independent variable from which this was derived was a binary variable. Even for what was originally a binary variable, the interval between these distinct values of the product of the standardized xᵢᵣ and 1 or −1 does have meaning in terms of an interaction between the relative distance from the expected average value of zero and whether or not the observation is in the reference choice condition. Hence, the t value should be interpretable as if this is an interval variable, even when the original variable used to create it was binary. Note that the t value cannot equal zero, so moments that have zero in the denominator should be excluded from a model.

Moment Definitions

With the understanding that w reflects the probability of error, the following information gives the structure of the moment constraints in Equation (2):

1) linear components: the first M/4 set of data moments are from r=1 to M/4. These constraints are standardized so that each vector xᵣ has a mean of 0 and a standard deviation of 1 across all C choice conditions and N observations that gave appropriate non-missing data. When missing data are present, imputation is performed after this standardization by setting all missing data to 0.

2) cubic components: the second M/4 set of data moments are from r=M/4+1 to M/2. These constraints are formed by cubing each standardized vector xᵣ from constraint set 1. If the original input variable that formed the linear variable was a binary variable, these components will not be independent from linear components and are dropped. When missing data are present, imputation is performed as in Constraint Set 1.

3) quadratic components: the third M/4 set of moments are from r=M/2+1 to 3M/4. These constraints are formed by squaring each of the standardized vectors from constraint set 1. If the original input variable that formed the linear variable was a binary variable, these components will not be independent from linear components and are dropped. When missing data are present, imputation is performed as in Constraint Set 1.

4) quartic components: the fourth M/4 set of moments are from r=3M/4+1 to M. These constraints are formed by taking each of the standardized vectors from constraint set 1 to the 4^{th} power. If the original input variable that formed the linear variable was a binary variable, these components will not be independent from linear components and are dropped. When missing data are present, imputation is performed as in Constraint Set 1.

Symmetrical Error Constraints

With these moment definitions, two additional sets of linear constraints are now imposed in this maximum entropy formulation above. These are constraints on w:

$$\begin{matrix}{\sum }_{j = 1}^{C} [ {\sum }_{r = 1}^{M} {s}_{r} {w}_{j 1 r} - {\sum }_{r = 1}^{M} {s}_{r} {w}_{j 2 r} ] = 0 & ( 6 ) \\ {\sum }_{j = 1}^{C} [ {\sum }_{r = 1}^{M} {w}_{j 1 r} - {\sum }_{r = 1}^{M} {w}_{j 2 r} ] = 0 & ( 7 )\end{matrix}$$

where sᵣ is equal to 1 for the first (linear) and second (cubic) of the groups of data constraints of size M/4 and −1 for the third (quadratic) and fourth (quartic) groups of data constraints of size M/4. Equation (6) forces the sum of the probabilities of error across the linear and cubic components to equal the sum of the probabilities of error across all the quadratic and quartic components. Equation (6) groups together the linear and cubic constraints that tend to correlate and matches them to quadratic and quartic components in likelihood of error. Equation (6) is akin to assuming that there is no inherent bias in the likelihood of error in the linear and cubic components vs. the quadratic and quartic components. Equation (7) forces the sum of the probabilities of positive error across all M moments to equal the sum of the probabilities of negative error across these same moments. Obviously, the constraints of Equations (6) and (7) are more likely to reflect reality as the number of moments increases.

Form of Solutions

The probability components in the solutions have the form:

$$\begin{matrix}{p}_{ij} = exp ( {β}_{j 0} + {\sum }_{r = 1}^{M} {β}_{jr} {x}_{ijr} ) / ( {\sum }_{j = 1}^{C} exp ( {β}_{j 0} + {\sum }_{r = 1}^{M} {β}_{jr} {x}_{ijr} ) ) & 8 ) \\ {w}_{1 jr} = exp ( {β}_{jr} {u}_{r} + {λ}_{j} + {τ}_{j} ) / ( {\sum }_{j = 1}^{C} exp ( {β}_{jr} {u}_{r} + {λ}_{j} + {s}_{r} {τ}_{j} ) ) & 9 ) \\ {w}_{2 jr} = exp ( - {β}_{jr} {u}_{r} - {λ}_{j} - {τ}_{j} ) / ( {\sum }_{j = 1}^{C} exp ( - {β}_{jr} {u}_{r} - {λ}_{j} - {s}_{r} {τ}_{j} ) ) & 10 )\end{matrix}$$

However, for the reference condition where j=C, the solutions have the normalization conditions described by Golan et al. (1996) where the vectors β_{c} and λ_{c} and τ_{c} are zero for all elements r=1 to M. Hence, the solution at j=C takes the form:

$$\begin{matrix}{p}_{ij} = 1 / ( 1 + {\sum }_{j = 1}^{C - 1} exp ( ( {β}_{j 0} + {\sum }_{r = 1}^{M} {β}_{jr} {x}_{ijr} ) ) ) & 11 ) \\ {w}_{1 jr} = 1 / ( 1 + {\sum }_{j = 1}^{C - 1} exp ( {β}_{jr} {u}_{r} + {λ}_{j} + {s}_{r} {τ}_{j} ) ) & 12 ) \\ {w}_{2 jr} = 1 / ( 1 + {\sum }_{j = 1}^{C - 1} exp ( - {β}_{jr} {u}_{r} - {λ}_{j} - {s}_{r} {τ}_{j} ) & 13 )\end{matrix}$$

where λ and τ are vectors of the solution parameters related to the two symmetrical sample error constraints across the C-1 choice conditions (Equations 6 and 7); the elements of λ and τ do not exist for the case where r=0, so w₁ⱼᵣ and w₂ⱼᵣ also do not exist for this case where r=0. In addition, β is a matrix of solution parameters related to the data moment constraints (Equation 2).

Extension to Ordered Dependent Variables

The multinomial logistic regression method that is outlined in the previous sections can be extended to situations where the dependent variable is a rank-ordered or interval-categorized variable, rather than a binomial or multinomial discrete category choice variable. This extension is exactly as in standard maximum likelihood logistic regression. That is, the probability estimate p now reflects a cumulative probability distribution across the C ordered or interval categories. In addition, the reference category should now be chosen to reflect the end category with the largest number of responses. Suitable adjustments should be made to the sign of the parameters to take into account whether the reference condition is minimum or maximum. Other than these very straightforward changes, the same methodology that is described throughout for multinomial non-ordered categories will apply to this logistic regression for ordered categories.

Extension to Repeated Measures/Multilevel Designs

The multinomial logistic regression method that is outlined in the previous sections can be extended to situations where the dependent variable exists in repeated measures or multilevel designs. This extension is exactly as in standard maximum likelihood logistic regression. That is, the meaning of the index i that designated “individuals” in the multinomial discrete choice formulation of Equation (2) can now be expanded to represent “individual measurements”. These “individual measurements” can be from the same individual at different points in time as in a repeated measures variable such as multiple items in a survey or experiment, or from different individuals within a multilevel variable such as a county or a state. Depending upon how each of the r moments are constructed, individual-level and aggregate-level moments can be formed to result in a repeated measures and/or multi-level design. Hence, the application to this repeated measures/multilevel design is very straightforward once one has an appropriate way to deal with how the largest expected error term uᵣ would change as a function of unequal numbers of observations in each of the moments. This is because most moments have missing observations in these repeated measure/multilevel designs. Without an appropriate correction for unequal Nᵣ in each of the r moments that is achieved by employing sqrt(Nᵣ) in the definition of uᵣ, one would have solutions that are biased by the number of missing observations.

Connections to Extreme Value Theory

This formulation is consistent with the Extreme Value characteristics surrounding logistic regression. To see this, first notice that for the rth moment, the ratio of the positive cross product sum error probability in the jth condition relative to that in the reference condition C is:

W₁ⱼᵣ/W_{1cr}=exp(−(−βⱼᵣuᵣ−λⱼ−sᵣτⱼ)) 14)

and the ratio of the negative cross product sum error probability in the jth condition relative to that in the reference condition C is:

W₂ⱼᵣ/W_{2cr}=exp(−βⱼᵣuᵣ−λⱼ−sᵣτⱼ) 15)

so for the j=1 to C-1 non-reference alternatives, the odds of cross product sum error in the positive direction is:

W₁ⱼᵣ/W₂ⱼᵣ=exp(−2(−βⱼᵣuᵣ−λⱼ−sᵣτⱼ)) 16)

### and the Logit is:

ln(W₁ⱼᵣ/W₂ⱼᵣ))=2βⱼᵣuᵣ+2λⱼ+2sᵣτⱼ 17)

Now, if we restrict the argument to the expression −βⱼᵣuᵣ−λⱼ−sᵣτⱼ to be greater than or equal to zero in Equation (14) and less than or equal to zero in Equation (15) such that any oppositely signed expressions yield zero results, then Equation (14) should be recognized as a cumulative form of the Weibull distribution and Equation (15) as a cumulative form of the Frechet distribution. That is, they now can be thought of as cumulative probability distributions that return values in the range of 0 and 1 that reflect the extent to which cross product sum error of a positive or negative variety is observed at the rth moment in the jth condition relative to the reference condition.

However, for the error corresponding to the Logit estimate and its coefficient in Equation (17), we expect a single cumulative probability distribution that estimates the probability of both positive and negative errors. Now, we recognize that the natural log of Weibull error observations correspond to Gumbel error observations. In addition, unlike Equations (14) and (15) that reflect probabilities, the value of the left hand side of Equation (16) will not reflect a probability if its exponential argument is unrestricted in sign but instead would be consistent with a non-negative Weibull error observation that can be greater than 1 because it also would be proportional to the ratio of the estimated positive to negative error of the rth cross product sum in the jth condition. Thus, we can view its natural log as a Gumbel or Extreme Value Type 1 error observation. This allows us to define the right hand side of Equation (17) as an error term Fr:

εⱼᵣ=2βⱼᵣuᵣ+2λⱼ+2sᵣτⱼ 18)

that equals 0 when the odds of error for this condition are equal to 1.

To get to the expected cumulative probability distribution for this error in Equation (18) as a function of these parameters, we take the negative of the error term in Equation (18) as the argument to an inner exponential function and we apply the negative of this as the argument to a second exponential function. The double negation in this case ensures that this function will always return a value in the range of 0 and 1 to reflect a cumulative probability and that a more positive value of εⱼᵣ always will be associated with a larger cumulative probability p(εⱼᵣ). These are the two fundamental properties that we expect of this probability distribution. This double negative exponential function is:

p(εⱼᵣ)=exp(−exp(−2βⱼᵣuᵣ−2λⱼ−2sᵣτⱼ)). 19)

This is the cumulative distribution function of the Extreme Value Type 1 or Gumbel distribution that first became known to Luce and Suppes (1965) and McFadden (1974) as a description of the probability distribution of the error associated with the Logit in discrete choice modeling. Note that the error εⱼᵣ in Equation (18) is the estimated error that exists after the logit coefficients have been adjusted to remove as much error as possible through this Reduced Error Logistic Regression method. To the extent that the symmetrical error constraints remove sampling error, rounding error and outlier error, this error term will be devoid of these sources of error. In addition, to the extent that the model is well-specified with enough informative moments, this error term will be devoid of underspecification error. Because the expected error term uᵣ would be error that is inversely proportional to at value, and the scale Ω is arguably the largest possible scale because it reflects the total magnitude across such t values, the expected error arguably reflects an extreme value and is consistent with Extreme Value Theory. However, due to the adjustment of this expected error through Equation (18), this actual estimated error εⱼᵣ is very small in magnitude with a large scale factor Ω. In addition, with a large scale factor Ω, the βⱼᵣ parameter in Equation (18) can be radically different from that same parameter estimated with the standard maximum likelihood method.

In the Multinomial Discrete Choice formulation, the random utility function is defined by:

Uᵢⱼ=Vᵢⱼ+εᵢⱼ 20)

where Utility or Uᵢⱼ is a function of Vᵢⱼ and εᵢⱼ is a random component that reflects unobserved characteristics of alternatives and/or individuals. Vᵢⱼ in Equation (20) results from taking the probability ratio of the ith individual in the jth choice condition relative to the reference choice condition for that individual. That is, from Equations (8) and (11):

$${V}_{ij} = ln ( {p}_{ij} / {p}_{ic} ) = {β}_{j 0} + {\sum }_{r = 1}^{M} {β}_{jr} {x}_{ijr} \qquad 21 )$$

The error εᵢⱼ in Equation (20) is assumed to be distributed independently and identically with the Gumbel distribution. To the extent the model is specified correctly and this error is distributed independently and identically as the Gumbel distribution and approximately sums to zero in aggregate, Vᵢⱼ is an approximation to Uᵢⱼ. However, with small sample sizes and large numbers of correlated independent variables, one can get radically different values for Vᵢⱼ simply by changing variables by values in the range of rounding error. In addition, it is not usually possible to get entirely orthogonal independent variables even in discrete choice experiments because the characteristics of the individuals usually cannot be manipulated experimentally. Therefore, we are almost always forced into some number of correlated independent variables, but we know that Vᵢⱼ is not a valid approximation to Uᵢⱼ with small sample sizes and any significant degree of correlation in the independent variables (i.e. multicollinearity).

To some extent, the present formulation avoids this unestimated error component εᵢⱼ. It assumes that 1) εᵢⱼ is simply a composite of the error across the r moments for the ith individual so it would be reasonable to consider subcomponents εᵢⱼᵣ, and 2) the odds of this error εᵢⱼᵣ being independent across the N individuals. With these assumptions, the present approach models the error εⱼᵣ aggregated across individuals for the rth moment and jth choice alternative as:

$${ɛ}_{jr} = {\sum }_{i = 1}^{N} {ɛ}_{ijr} \qquad 22 )$$

and defines this error as a function of the parameters in Equation (18). This implies:

$$\begin{matrix}{ɛ}_{j} = {\sum }_{i = 1}^{N} {ɛ}_{ij} \\ or & 23 ) \\ {ɛ}_{j} / N = \overline{{ɛ}_{j}} = {\sum }_{r = 1}^{M} ( 2 {β}_{jr} {u}_{r} + 2 {λ}_{j} + 2 {s}_{r} {τ}_{j} ) & 24 )\end{matrix}$$

so at least we can estimate the average value of εᵢⱼ across the N individuals for the jth choice condition. If there is more than one informative moment in Equation (24), then the symmetrical error constraints should force this average error to be close to zero. Thus, we do not have to include any error components in our definition of Utility because we have estimated Vᵢⱼ through a method that controls for this average value of εᵢⱼ. As a result, we can remove any reference to εᵢⱼ in the definition of utility. This gives the following estimate for utility:

Uᵢⱼ≈Vᵢⱼ 25)

This Reduced Error Logistic Regression method that controls for the average estimate of εᵢⱼ across the N individuals in the jth choice condition, and removes it, should be more accurate on average than assuming that εᵢⱼ sums to zero across alternatives and individuals. Hence, our estimate of Utility in Equation (25) should be more accurate on average than the Standard Maximum Likelihood formulation estimate in Equation (20) where there is an implicit assumption that each εᵢⱼ can be effectively treated as zero such that Vᵢⱼ is interpreted to be a good estimate of Uᵢⱼ. In reality, Vᵢⱼ can be radically misestimated in the standard maximum likelihood formulation. This is likely because the sum of εᵢⱼ across individuals and alternatives might be especially different from zero with small sample sizes and large numbers of correlated independent variables, and this corrupts the estimate of Vᵢⱼ (i.e. multicollinearity).

A major factor affecting accuracy is a large enough sample of individuals for a reliable average error estimate. This will be data dependent and depend upon factors like the extent of the correlation between the independent variables, the number of target responses, whether the independent variable is an interval or non-interval variable, and the extent to which independent variables have values in the sample that are representative of their range. A second major factor related to accuracy is the number of attributes of individuals and choices in the model. Both the symmetrical error constraints (Equations 6 and 7) and the assumption that εᵢⱼ reflects unobserved characteristics of individuals and/or choices imply that more informative moments in Equation (2) will give a more accurate model. On the other hand, simply adding non-informative or random moments would not help the quality of these estimates.

Standard maximum likelihood logistic regression models are unlikely to exhibit independence from irrelevant alternatives (IIA). IIA requires that the probability ratio of any two alternatives is independent of the presence or absence of all others in a choice set. For example, IIA would require that the addition of Ralph Nader into the George Bush vs. John Kerry 2004 U.S. presidential election would make no difference to the outcome. This is quite often very unrealistic. However, even when this IIA condition is met, underspecified models that do not include enough informative moments can still exhibit problems related to IIA (McFadden, 2002). The reason is that not having enough informative moments increases the unobserved characteristics of alternatives and individuals corresponding to the errors in Equation (20). If these errors are correlated across alternatives or individuals, this violates assumptions of the standard multinomial logit model that the error is independently and identically Gumbel distributed error. A number of multinomial logit approaches have been introduced that try to relax the restriction concerning correlated error patterns, but these approaches have not received widespread application. Because the average error ε̅j̅ across individuals and moments defined in Equation (24) should be close to zero (due to the symmetrical error constraints), the present method avoids problems related to this error. Essentially, symmetrical error constraints in this reduced error method serve the same purpose as is served by the requirement that the Gumbel error in standard logistic regression is independently and identically distributed. This purpose is that the error should approximately sum to zero in aggregate across individuals and alternatives.

Generalized Reduced Error Logistic Regression models built from one specific choice set will not necessarily generalize to new choice sets that add or remove new alternatives. This is akin to how least squares regression models do not necessarily extrapolate outside of the range of values of independent variables used to build the model. The reason is due to the IIA requirements; the definition of Utility defined through Equations (21) and (25) does not depend upon any other alternatives in the choice set. Hence, a model that defines the Utility built from just one choice set corresponding to Bush vs. Kerry will not be able to adjust to the addition of a new alternative such as Nader in a new choice set, unless the probability ratio of the Bush vs. Kerry votes does not depend upon Nader. The Generalized RELR solution is to build sub-models for each different choice set that includes or removes different alternatives. Thus, the present approach handles the addition or removal of irrelevant alternatives through the construction of sub-models such as for the Bush vs. Kerry and the Bush vs. Kerry vs. Nader choice sets that characterized the 2004 U.S. presidential election (please see example models). Note that the term “irrelevant alternatives” is actually a misnomer in the IIA literature, as we are concerned with what is a relevant new alternative such as the Nader alternative.

Alternatively, a grand model might be constructed to build all sub-models across all choice sets simultaneously through Generalized RELR. If error were a problem in this method, as it would be for standard logistic regression, one would expect differences between sub-models as a function of whether they were produced simultaneously vs. separately. This is clearly not the case, as shown in the Results Section herein below. This gives a Generalized RELR methodology that can automatically adjust its parameters to deal with the addition or removal or alternatives, so IIA need not be assumed with the sub-models that are produced in Generalized RELR. The critical caveat is that we can only generalize to those choice sets that were used to produce the sub-models; we cannot extrapolate to new choice sets that were not used to build sub-models.

As the sample size N gets very large, the magnitude of the cross product sums in the left hand side of equation (2) will also get very large, provided that these are informative moments that reflect non-random relationships. However, the magnitude of uᵣ does not increase at this same rate with increasing N, but instead should remain fixed given that tᵣ would be expected to increase at the same rate as sqrt(Nᵣ), and given that uᵣ is built from the ratio of these two values as shown in Equations (5a) and (5b). This implies that this magnitude |uᵣ| will eventually be of negligible size in relation to the magnitude of the rth cross product sum at large sample sizes for an informative moment; so, the symmetrical error constraints across a solution that contains only informative moments would become trivial constraints. On the other hand, non-informative moments would have t values that tend to zero with large sample sizes, but these moments would be dropped very early in the variable selection process (see below). Therefore, provided that this method can drop non-informative variables to get a solution that includes only informative moments, this method's solution and the standard maximum likelihood (Multinomial Discrete Choice) solution would eventually converge as the sample size gets large. As the symmetrical error constraints become less important constraints, and the positive and negative cross product sum error estimates are of negligible magnitude in relation to the cross product sums with a large N, the reduction of error through this method would also become negligible. This convergence to the standard maximum likelihood solution would be expected to happen more rapidly for cases with few informative moments, as the variable selection process would discard non-informative moments more rapidly with increasing N, so to result in relatively small values of 0 (see below). Small magnitude 0 solutions will always be closer to standard maximum likelihood solutions.

Variable Selection

When the scale factor Ω is large and the sample size is relatively small, the βⱼᵣ parameters in Equation (18) can be radically different from those same parameters estimated with the standard maximum likelihood method. This is precisely when the standard maximum likelihood solution would not be expected to be accurate. At large values of Ω, the probability of positive and negative error in the cross product sum become almost equivalent, so the εⱼᵣ values go to zero for all j and r. Because the Lagrangian multipliers also get larger and more nontrivial with increasing Ω at a fixed sample size, and because the magnitude of uᵣ also increases with increasing Ω, the βⱼᵣ parameters necessarily are smaller in magnitude to ensure that values of εⱼᵣ are close to zero. These relationships are critical to the understanding of the variable selection process.

There is a basic relationship between the t value tᵣ and the logit coefficient βⱼᵣ that follows from Equation (18):

(tᵣ/\sqrt{Nᵣ})(−2λⱼ−2sⱼτⱼ+εᵢⱼ)/Ω=βⱼᵣ 26)

When Ω is large and the error term εⱼᵣ is close to zero for all j and r, then this relationship simplifies to:

(tᵣ/\sqrt{Nᵣ})(−2λⱼ−2sᵣτⱼ)/Ω≈βⱼᵣ 27)

We know that the expression −2λⱼ−2sᵣτⱼ corresponding to all linear and polynomial components will be equal across all r=1 to M/2 moments for the jth choice condition. This same expression will also be equal across all quadratic and quartic components corresponding to r=M/2+1 to M moments for the jth condition. This simply follows from the definitions of these various components. If only linear components are included in a model, then this same expression also would be equal across all linear components for the jth condition. Therefore, provided that the scale Ω is large enough, then we can rank order the importance of all linear and polynomial moments for the jth choice condition simply in terms of the magnitude of tᵣ/\sqrt{Nᵣ}. Likewise, we can order the importance of all quadratic and quartic moments simply in terms of this same magnitude, as this rank ordering also will correspond to the rank ordering of the magnitude of their βⱼᵣ coefficients for the jth choice condition across the r=M/2+1 to M moments.

Due to these relationships, we can build a model with the most important odd polynomial moments and the most important even polynomial moments and the relative ordering of the βⱼᵣ coefficients will be the same as if we had constructed a model across all M moments. This reduces the potential dimensionality of the model enormously, because we only need to build models based upon the reduced set that contains the most important moments. Furthermore, we can define this most important set of moments before we build a model. Once again, if this is a polynomial model, we need to consider the most important odd and even polynomials separately in terms of the magnitude of tᵣ/\sqrt{Nᵣ} in the definition of the most important variable set. If this is a linear model, we can order the importance of moments simply on the basis of the magnitude of tᵣ/\sqrt{Nᵣ}.

Hence, we can start with a subset of all possible moments, build a model, and gradually remove variables to create successively smaller sets of variables in new successive models. We do this by dropping the least important odd and even numbered polynomial components at each step in the variable selection process, rebuild a model, and check its accuracy. At the end of this process, we want the model with the greatest accuracy. If there is a tie in the accuracy across different numbers of variables, we want the variable set with the smallest number of variables. Because we can now start with a much smaller set of variables than the total variable set, this process overcomes the dimensionality problem that plagues predictive modeling. The only caveat is that we will need to produce t values for all variables in the total variable set, as at value corresponding to each variable is needed to determine variable importance.

As we reduce the number of variables in this variable selection process, Ω will get smaller and smaller in magnitude, so that eventually not all εⱼᵣ terms will be close to zero. When this happens, the magnitudes of the βⱼᵣ coefficients will no longer maintain the same invariant relative ranking as existed with larger numbers of variables. However, the magnitude of the ratio βⱼᵣ/εⱼᵣ will still maintain this invariant rank order relationship across the r moments based upon the magnitude of the ratio tᵣ/\sqrt{Nᵣ} as demonstrated in Equation (28). Arguably, with error components εⱼᵣ that are non-zero, a definition of moment importance that includes this significantly non-zero error would be more appropriate, so the magnitude of the ratio tᵣ/\sqrt{Nᵣ} can still be used to order the moment importance that is now in the form of the magnitude of the ratio βⱼᵣ/εⱼᵣ even when Ω gets small. Once again, this importance ordering should be done separately for odd and even polynomial moments when a polynomial model is constructed.

(tᵣ/\sqrt{Nᵣ})(−2λⱼ−2sᵣτⱼ+1)/Ω=βⱼᵣ/εⱼᵣ 28)

As Ω gradually get smaller and smaller with variable reduction, the Lagrangian multipliers λⱼ and τⱼ that resulted from the symmetrical error constraints get smaller and smaller in magnitude as these symmetrical error constraints approach triviality. Eventually, with only one variable, these Lagrangian multipliers would actually become trivial constraints. As this happens, we can rewrite Equation (28) as:

(tᵣ/\sqrt{Nᵣ})/Ω≈βⱼᵣ/εⱼᵣ 29)

At each step in the variable reduction process, we check the accuracy of the model through a standard approach such as the training sample's misclassification rate. In addition, we check the accuracy of a similar model that does not include Equation (6) which concerns the constraints that force the probability of positive and negative error for the linear/cubic components to equal that for the quadratic/quartic components. At some point in the variable reduction process, we expect that there will be too few variables for the Equation (6) constraint to be reasonable. That is, we expect that the Equation (6) constraint that forces the probability of positive and negative error to be equal across the odd and even polynomial components separately would become unreasonable with small numbers of variables because its symmetry is based upon half the number of variables as the Equation (7) constraint which forces error probability to be equal across all variables. For this reason, at the point in the variable reduction process when the training sample's model accuracy is better without Equation (6) than with it, we drop Equation (6) as a constraint in the model. Once Equation (6) is no longer imposed, then we drop the least important odd or even polynomial component simply based upon the smallest magnitude t value. That is, we would no longer have to consider odd and even polynomial components separately in the variable reduction process because the 2sᵣτⱼ terms in Equations (26)-(28) would now be zero, so there would no longer be differentiation in variable importance due to the odd or even order of the polynomial. This implies that the model could converge to a completely linear solution based upon these variable selection rules without an a priori linear assumption on the part of the analyst. However, if an analyst wishes to assume entirely linear models, this functionality is also present for convenience purposes.

This completes the explanation of the variable selection process. This process will be easier for a model that only contains linear components, as it does not include the Equation (6) constraint and its associated Lagrangian multiplier τⱼ. This is a completely “mechanical” process that leads automatically to one best model which is the model with the lowest error in the training sample. In the case of a tie between models with different numbers of variables, it is the model with the lowest error in the training sample and the least number of variables.

Use of the Method

What follows are examples of the use of the method of the invention.

Computation of Solutions

Following the Soofi (1992) demonstration of the equivalence of the Maximum Entropy and Maximum Likelihood formulations of Multinomial Discrete Choice models, there are two possible ways to obtain a solution to this Maximum Entropy formulation. One of these would be to calculate the Maximum Entropy solution. A second way would be to solve it as a Maximum Likelihood solution. These procedures give equivalent solutions in SAS using Proc Entropy for the Maximum Entropy solution and Proc Logistic or Proc Genmod for the Maximum Likelihood solution. However, the Proc Logistic or Genmod procedures have an advantage in that they produce standard errors on the estimates automatically. In addition, these maximum likelihood procedures converge much more rapidly to an optimal solution. Also, Proc Entropy is still an experimental SAS procedure and still has a fair number of bugs. For those reasons, the solutions that are reported here are from Proc Genmod and Proc Logistic.

Example Bush vs. Kerry Models Based on a Political Polling Dataset

Data were obtained from the Pew Research Center's 2004 Election Weekend survey. This is a public domain dataset that can be downloaded from their website. The survey consisted of a representative sample of US households. Respondents were asked about their voting preference on the weekend before the 2004 election. 2358 respondents met the criteria of this first model which only employed those respondents who indicated that they would vote for Bush or Kerry without regard to whether Nader was in the race. In addition to voting patterns, this survey collected demographic and attitude data. These demographic and attitude responses were employed as independent variables in the predictive models. Examples of attitude questions were whether respondents agreed with the Iraq war and whether respondents thought that the US was winning the war against terrorism.

The dependent variable was Presidential Election Choice (Bush vs. Kerry). Kerry was the target condition. There were 14 interval variables and 41 binary variables that resulted from coding the survey responses into independent variables. Generalized RELR produced new variables from these input variables corresponding to two-way interactions and polynomial terms where appropriate. 1540 variables resulted in total; and the 400 most important variables were input into the model. This corresponded to the 200 most important linear/cubic variables and the 200 most important quadratic/quartic variables as a starting condition. Variables were then reduced in accordance with the Generalized RELR variable selection methodology that has been previously outlined. The models were run within SAS Enterprise Miner 5.2 using the extension node methodology.

Bush vs. Kerry models were also run within Enterprise Miner 5.2 using the Support Vector Machine, Partial Least Squares, Decision Tree, Standard Logistic Regression and Neural Network methods. The default conditions were employed in all cases except Standard Logistic Regression where two way interactions and polynomial terms up to the 4^{th} degree were specified and Support Vector Machines where the polynomial method was requested. The identical variables and samples were employed as inputs in all cases. Misclassification Rate was employed as the measure of accuracy in all cases.

In a first “smaller sample” model, the training sample consisted of a random sample of 8% or 188 observations. The remainder of the overall sample defined the validation sample. In a second “larger sample” model, the training sample consisted of a random sample of roughly 50% or 1180; the remainder of this sample defined the validation sample. The 2004 election was very close, as roughly 50% of the respondents opted for Kerry in all of these sub-samples. Target condition response numbers are indicated in the results charts.

Like most political polling datasets, there was a wide range in the correlation between the original 55 input variables that went from roughly −0.6 to about 0.81. These correlation magnitudes were even larger for many of the interactions produced by Generalized RELR, so this dataset clearly exhibited multicollinearity. In addition, there was significant correlation to the dependent variable in a large number of variables. This dataset would be classified as containing many informative variables.

Results of Bush vs. Kerry Models Based on a Political Polling Dataset

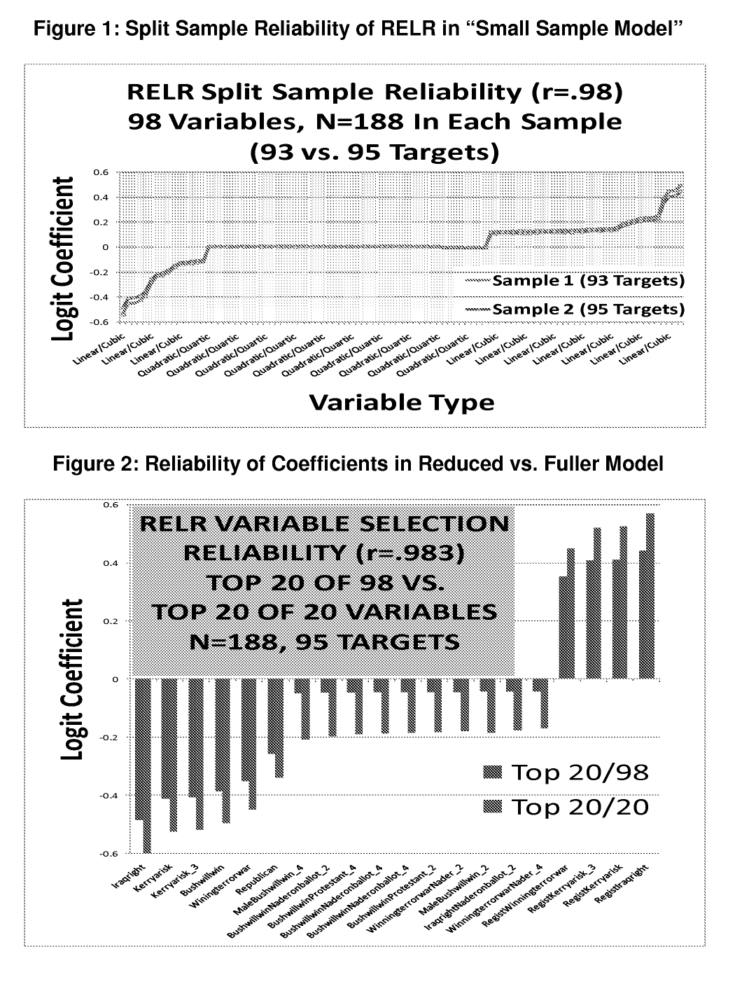

FIG. 1 shows the split sample reliability of the logit coefficients from two randomly split and completely independent sub-samples each corresponding to roughly 8% of the total sample across the top 98 variable importance set. This correlation is approximately 0.98. These are highly reliable split-sample models that clearly break the 10:1 rule that requires 10 times the number of independent variables as target responses (Peduzzi et al., 1996).

### FIG. 1: Split Sample Reliability of RELR in “Small Sample Model”.

FIG. 2 shows the correlation between the logit coefficients from the 20 most important variables in a model that included 98 total variables vs. a model that only included these 20 variables. Notice, that there is a large correlation between these two sets of logit coefficients. This corresponds to the situation referenced in Equation (27) where the relative magnitudes of the logit coefficients are extremely stable with respect to variable reduction.

FIG. 2: Reliability of Coefficients in Reduced vs. Fuller Model.

Notice that the signs of the logit coefficients in FIG. 2 do make sense. Those respondents who believe that “Iraq was right” or “Kerry is a risk” are extremely unlikely to vote for Kerry as suggested by strongly negative logit coefficients in a model where Kerry is the target condition. On the other hand, there is a strong positive interaction between registration status and these same two questions. The non-registered voters were a low frequency condition, so they were associated with very negative standardized values of the registration status variable. The frequency of the registered voters was close to zero in this standardized variable. Hence, interactions involving this registration status variable were largely negatively weighted by the non-registered condition. When multiplied by other negative values corresponding to observations where people do not believe that “Iraq was right” or do not believe that “Kerry is a risk”, this gave positive values of this interaction variable. People with positive values of interaction variables that were weighted largely by non-registration status were the strongest supporters of Kerry as suggested by the strongly positive logit coefficients.

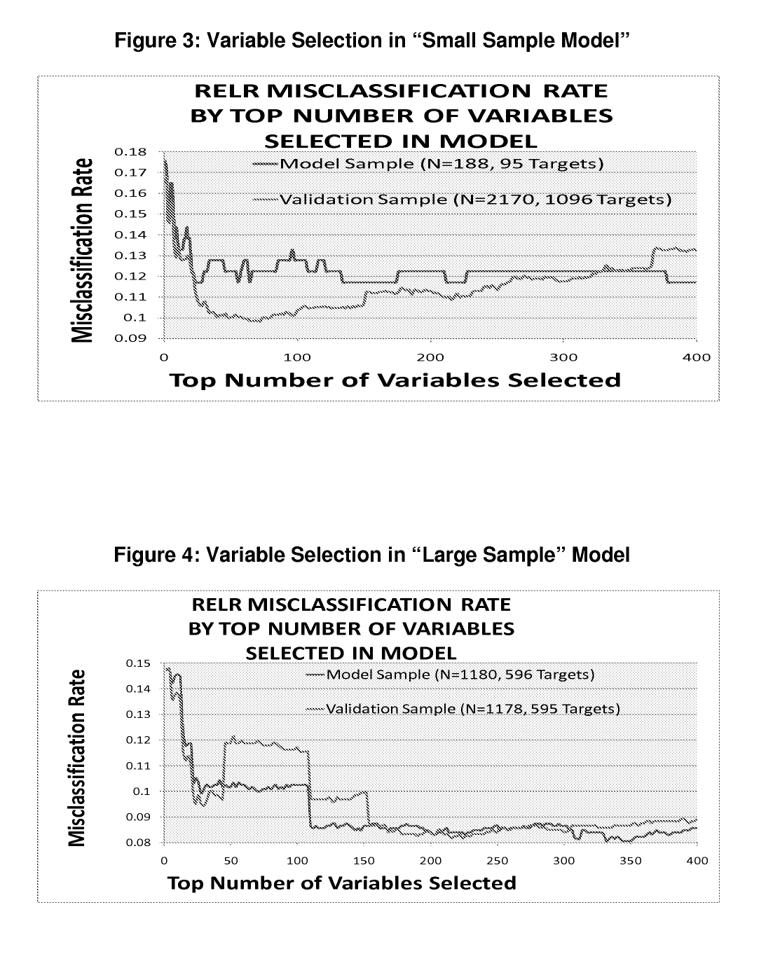

FIG. 3 shows the trajectory of the misclassification error corresponding to variable selection in the “small sample” 2004 Election Weekend Bush vs. Kerry Generalized RELR model. The best model occurred with 24 variables in the model. This corresponds to the training model with the lowest error and the fewest number of variables. FIG. 4 shows this same trajectory in the “large sample” Generalized RELR model. The “large sample” model was significantly more accurate. Its best model occurred with 344 variables.

### FIG. 3: Variable Selection in “Small Sample Model”.

### FIG. 4: Variable Selection in “Large Sample” Model.

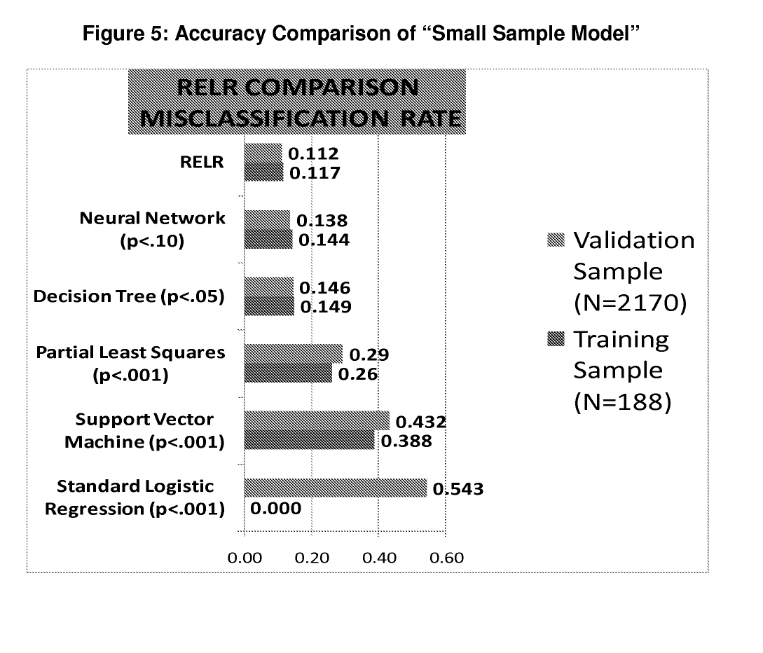

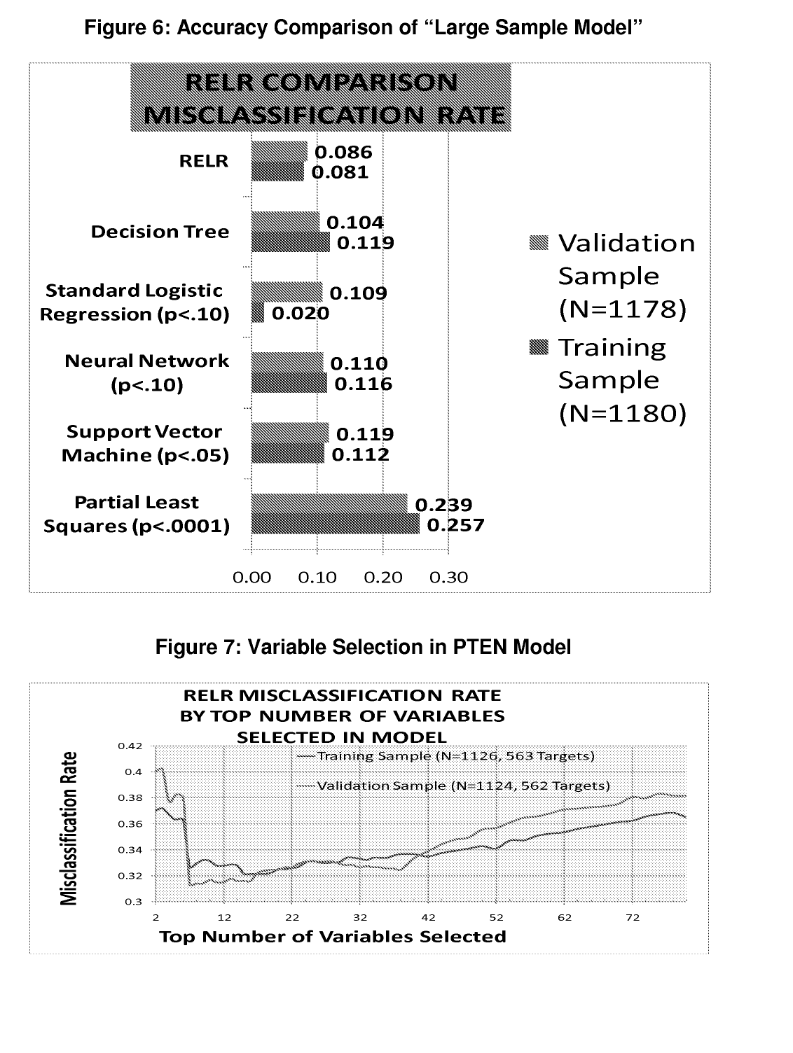

FIG. 5 compares the accuracy of Generalized RELR to the other predictive modeling methods in the Bush vs. Kerry “small sample” model. The probability levels in that figure are from chi-square tests that compare the number of error trials found in the validation sample of Generalized RELR to that found in the validation sample of the other methods. FIG. 6 shows these same comparisons for the Bush vs. Kerry “large sample” model. These results suggest that Generalized RELR had better validation sample accuracy than a set of commonly used predictive modeling methods that include Standard Logistic Regression, Support Vector Machines, Decision Trees, Neural Networks, and Partial Least Squares. The critical caveat is that there were a large number of informative variables in both of these models. The small sample model had a Ω value of 42.76 in its best model. The large sample model had a Ω value of 161.77 in its best model.

### FIG. 5: Accuracy Comparison of “Small Sample Model”.

### FIG. 6: Accuracy Comparison if “Large Sample Model”.

Example Model Based on PTEN Stock Price Data

Stock price data from Patterson Energy (Nasdaq symbol: PTEN) from Aug. 11, 1997-Aug. 8, 2006 were collected through the Reuter's Bridge Workstation QuoteCenter Product. Six variables that reflected the very short term price trend of PTEN were employed. They measured the % change between its open price and recent other price points such as previous open price, its previous close price, and its previous high. From these six interval variables, 130 other variables were computed based upon up to 5 way interactions and 4^{th} order polynomials. The 80 most important variables became input variables. The dependent variable was based upon the % change in PTEN's price from one day's opening to the next day's opening. This variable was encoded into a binary dependent variable that reflected whether the stock price went up or down. An interval dependent variable would have also been appropriate. We found similar results when we used the Ordinal Logit formulation of Generalized RELR on interval-categorized encoding, but we wanted to use a binary dependent variable so we could continue to use Misclassification Rate to compare to other predictive modeling methods within Enterprise Miner.

The independent variables in this model were very poorly correlated to stock price % change and to its binary transform. Only a very few variables showed significant correlation to stock price change. These independent variables would largely be classified as non-informative variables.

Results of PTEN Stock Price Data Model

FIG. 7 shows the trajectory of the misclassification error corresponding to variable selection in the “small sample” Generalized RELR model.

### FIG. 7: Variable Selection in PTEN Model.

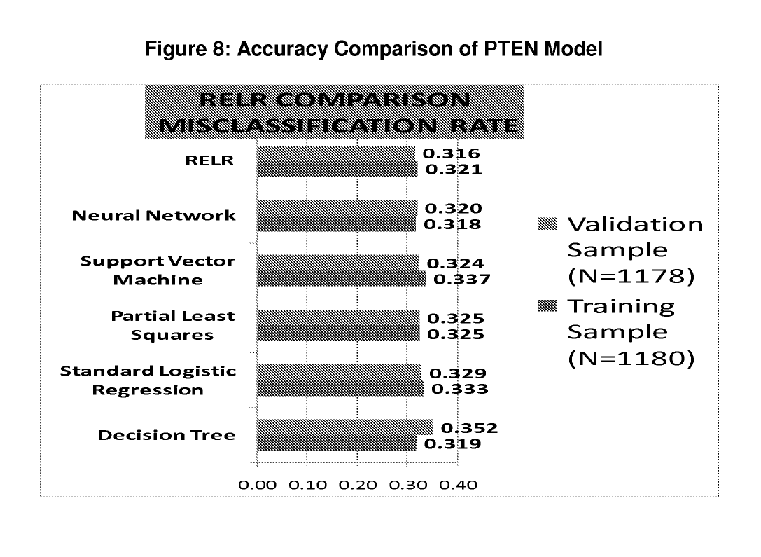

The best model occurred with 15 variables in the model. This corresponds to the training model with the lowest error and the fewest number of variables. FIG. 8 compares the accuracy of RELR to the other predictive modeling methods in this PTEN model. There were no statistically significant differences between these methods with regard to accuracy. This PTEN model had a Ω value of 2.63 in its best model. This was significantly below the value of Ω in the two political polling models. This is consistent with the small number of informative variables in this PTEN dataset.

### FIG. 8: Accuracy Comparison of PTEN Model.

Example Model Based on 2004 US Election Polling Repeated Measures Data

To demonstrate the capacity of Generalized RELR to produce a model based upon more than one multinomial choice set involving different alternatives in a repeated measures context, the same Pew 2004 Election Weekend dataset is employed. In this case, we include two different choice sets that involve different alternatives. The first set has as its target variable reference the choice of Kerry when the alternative is Bush or Kerry. The second set has as its target variable reference the choice of Kerry when the alternative is Bush, Kerry, or Nader. These specific questions were asked as a part of that survey on the weekend prior to the election in 2004.

54 of the same 55 variables that were included as inputs in the Bush vs. Kerry model used above were included as inputs in this model. The variable related to whether Nader should be on the ballot was excluded because it had zero variability in the Nader group. Interaction terms were formed between the presence or absence of each of these two choice sets and the remaining 54 variables in a repeated measures design. This resulted in 108 variables that reflected these interactions. In this case, no variable selection was performed, as the primary emphasis was to show that a simultaneous model for both choice sets gives roughly the same results as separate models for each choice set.

Results of Bush vs. Kerry and Bush vs. Kerry vs. Nader Repeated Measured Models

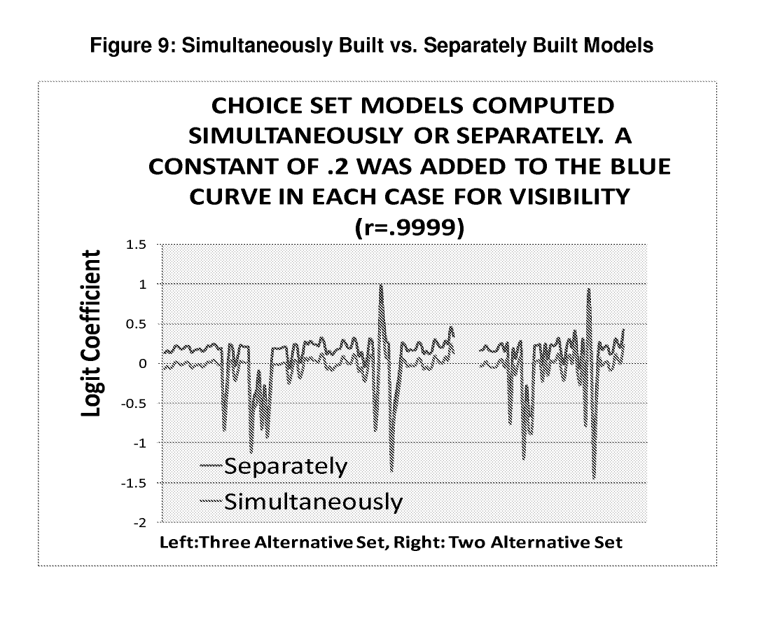

The results are shown in FIG. 9. The correlation between the Logit coefficients in models that we built separately to the Logit coefficients in the model that employed both choice sets simultaneously was approximately 0.9999. This suggests that grand simultaneous model built from more than one sub-model reflecting different choice sets is feasible. One could always still build separate models, but the simultaneous models would be easier to build and maintain all at once.

FIG. 9: Simultaneously Built vs. Separately Built Models.

Key Differences Between Non-Generalized and Generalized RELR

The following sections reiterate in more detail the key novel and non-obvious features of Generalized RELR that allows it to generalize to predictive modeling scenarios that are mostly beyond the capability of non-generalized RELR. In some cases, empirical evidence not shown in previous sections is provided to support these claims of the superiority of Generalized RELR.

Unequal Numbers of Non-Missing Observations across Variables

Generalized RELR has its largest expected error term defined in Equation (5a). The t value is divided by sqrt(Nᵣ) in the denominator of Equation (5a). This is different from that defined for non-generalized RELR (Rice, 2006b). The difference is that there is no division by sqrt(Nᵣ) in Rice (2006b), so there is no effective weighting by the number of non-missing observations for this term in the non-generalized RELR public disclosures summarized as Rice (2006b).

The present inventor also submitted a provisional patent in January, 2007 that largely was based upon revising the Rice (2006b) formulation of RELR to deal with unequal numbers of non-missing observations. The equivalent to this t value was divided by Nᵣ in that provisional patent application instead of by its present value of sqrt(Nᵣ). The justification in the January, 2007 provisional application was based upon abstract theoretical arguments. However, we now know, on the basis of very direct empirical evidence, that this should be divided by sqrt(Nᵣ) to get logit coefficients that are relatively unbiased by the number of non-missing observations.

This direct empirical evidence is based upon an experiment involving two logit coefficients. These logit coefficients arise from two independent variables: Variable A and B. Variables A and B are identical to one another in half of the dataset. In the other half of the dataset, Variable A is simply a duplicate of itself across all observations, whereas Variable B is missing. That is, observation N/2+1 is equivalent to observation 1, observation N/2+2 is equivalent to observation 2, . . . , observation N/2+N/2 is equivalent to observation N/2 for Variable A, but all observations in the second half of the dataset are missing for Variable B. We seek the weighting factor that is associated with the least amount of change in the logit coefficients, as the effect of Variables A and B on the dependent variable is identical. The only difference between Variables A and B is that Variable B has twice the number of non-missing observations. The logit coefficients corresponding to Variables A and B are now compared when three different weighting factors are used in Equation (5a). One is sqrt(Nᵣ) as in Equation (5a), a second is simply 1 or no weight, a third is Nᵣ. Table 1 shows a typical result from such an experiment. The variable that was used was Question 8 from the Pew 2004 Election Weekend Survey described previously. This sample had 1641 non-missing values of Question 8 originally as Variable A; the Variable B that duplicated this had 3282 observations. The logit model was run at a large value of Ω with 220 mostly informative variables used, so the Extreme Value errors on the Logit coefficients described in Equation (18) were very small.

Table 1 shows the results of this experiment with Question 8 of this Pew survey.

TABLE 1
EFFECT OF WEIGHT IN EQUATION
5A ON LOGIT COEFFICIENT

| Weight | Coefficient (n = 3282) | Coefficient (n = 1641) |
|---|---|---|
| None | .48 (.04) | .33 (.04) |
| Sqrt(Nᵣ) | .64 (.03) | .63 (.04) |
| Nᵣ | .64 (.03) | .90 (.05) |

*Standard Error of Logit Cofficient is shown in parentheses

Note that the standard error that is reported is a chi-square based statistic from SAS Proc Genmod that is adjusted for missing values. This standard error does not reflect any underspecification error like the error described in Equation (18), but instead entirely reflects sampling error. The Table 1 results show that the weight of sqrt(Nᵣ) was clearly associated with logit coefficients that did not change significantly as a function of the number of non-missing observations. On the other hand, there were significant changes in the other two conditions. This experiment is a typical result with a relatively large Ω value and a reasonably large number of non-missing observations. This experiment suggests that the sqrt(Nᵣ) weight is associated with logit coefficients that are not biased by the number of non-missing observations, whereas this is not true for the other two weighting factors in Table 1.

The reason that the January, 2007 provisional patent application did not come to this conclusion is that it did not look at the sqrt(Nᵣ) as a possible weight. Instead, it only compared no weight and Nᵣ as possibilities. In addition, it did not perform a direct experiment on logit coefficients like this experiment, but instead used a very indirect comparison involving misclassification error across all variables in training and not in validation samples. The present experimental methodology is superior; it also includes the crucial relevant experimental condition involving sqrt(Nᵣ).

Those skilled in the art will understand that this weighting in the denominator of Equation (5a), to account for non-missing observations should be proportional to sqrt(Nᵣ), makes sense when one considers that the one sample t value increases in proportion to sqrt(Nᵣ) in random samples for effects that are not due to chance. Hence, the sqrt(Nᵣ) weighting in the denominator of Equation (5a) controls for the number of non-missing observations in the tᵣ value in that denominator.

Definition of Ω Scale Factor Tied to Total Informative Value of Independent Variables

A second key difference between Generalized RELR and non-generalized RELR concerns the definition of Ω. Non-generalized RELR defined this to be the “largest scale value where convergence occurs”. On the other hand, Generalized RELR ties this scale factor Ω to the total informative value of the independent variables through Equation (5b).

When the scale factor Ω defined through Equation (5b) is large, the solutions will be highly correlated to the solutions with the Ω defined as the largest scale value where convergence occurs. However, the solutions will be different at lower values of Ω. As an example, the Generalized RELR solution for the “large sample” Pew Election Weekend survey model had a relatively large value of Ω of 161.77. This solution would have been quite similar if Ω had been defined, as in non-generalized RELR, as the arbitrarily largest possible scale factor where convergence occurs. However, the PTEN stock price model has a relatively small value of Ω of 2.63. In this case, the solutions differed significantly. In fact, the Generalized RELR model where Ω=2.63, had a significantly lower misclassification rate and number of variables in comparison to the model that would have been obtained with an arbitrarily large value of Ω.

TABLE 2
EFFECT OF Ω ON PTEN MODEL QUALITY

| | Arbitrarily Large Ω | Ω = 2.63 |
|---|---|---|
| Misclassification Rate | 0.407 | 0.316 |
| Number of Variables | 80 | 15 |

* Misclassification rates are from the validation sample

The problem with too large of a scale factor Ω seems to be that the model underfits the total informative value of variables that are present. By directly connecting Ω to a measure of the total informative value of variables, Generalized RELR appears not to underfit the informative aspect of the data, but instead appears to produce an optimal fit.

Repeated Measures and Multilevel Designs

Generalized RELR allows repeated measures and/or multilevel models. An example of such a model was provided with the Pew 2004 Election poll that asked respondents about both Bush vs. Kerry and Bush vs. Kerry vs. Nader. A key reason that Generalized RELR works with these designs is that it does not need to assume that all moments have the same number of non-missing observations, as these designs have many moments with missing data. The Rice (2006b) disclosure of non-generalized RELR did not apply to repeated measures/multilevel designs. The January, 2007 provisional patent application did assert that it applied to repeated measures/multilevel designs. However, this assertion was based upon a sub-optimal way to handle non-missing observations through a weighting in the denominator of Equation (5a) that was proportional to N, rather than the optimal weighting of sqrt(N) as was previously described in the section on unequal numbers of non-missing observations.

Precise Quantitative Rules for Variable Selection

Generalized RELR includes precise quantitative rules for optimal variable selection. These rules were not in the Rice (2006b) manuscript or the January, 2007 provisional patent application on non-generalized RELR. This automated variable selection method is a very important feature of Generalized RELR, as otherwise there would be wide potential diversity in model accuracy and the variables selected into the model. Users can always choose to override these automated variable selection features, but these precise quantitative rules remove any arbitrary factor in model building. Instead, these rules give what appears to be a very accurate model. In view of the above, it will be seen that the several objects and advantages of the present disclosure have been achieved and other advantageous results have been obtained.

### REFERENCES

Allenby, G. M. and Peter E. Rossi (1999). Marketing models of consumer heterogeneity, Journal of Econometrics, 89, 57-78.
LeBlond, D. (2007). Discussion of MCMC convergence problems in logistic regression in BUGS email discussion group.
Luce, R. D. and Suppes, P. (1965). Preference, utility and subjective probability, in R. D. Luce, R. R. Bush and E. Galanter (eds), Handbook of Mathematical Psychology, Vol. 3, John Wiley and Sons, New York, N.Y., pp. 249-410.
Luce, R. D. (1959). Individual Choice Behavior: A Theoretical Analysis. New York: Wiley.
Magidson, J., Eagle, T., & Vermunt, J. K. (2005) Using parsimonious conjoint and choice models to improve the accuracy of out-of-sample share predictions. Paper presented at the 16^{th} annual Advanced Research Forum of the American Marketing Association in Monterrey, Calif.
McFadden, D. (1974). Conditional Logit Analysis of Qualitative Choice Behavior. In P. Zarembka (ed) Frontiers in Econometrics, New York, Academic Press, pp. 105-142.
McFadden, D. (2002). Logit. Online book chapter: http://elsa.berkeley.edu/choice2/ch3.pdf.
Peduzzi, P., J. Concato, E. Kemper, T. R. Holford, and A. Feinstein (1996). A simulation of the number of events per variable in logistic regression analysis. Journal of Clinical Epidemiology 99: 1373-1379.
Rice, D. M. (2005). A new distribution-free hierarchical Bayes approach to Logit Regression.
In Proceedings of the 70th Annual Psychometric Society Meeting in Tilburg, Netherlands. Rice, D. M. (2006a). Logit regression with a very small sample size and a very large number of correlated independent variables.
In Proceedings of the 71st Annual Psychometric Society Meeting in Montreal, Quebec. Rice, D. M. (2006b). A solution to multicollinearity in Logit Regression. Public domain manuscript distributed to attendees of the 2006 Psychometric Society Meeting. (Please see Appendix 1).

Having thus described the invention, what is claimed and desired to be secured by Letters Patent is:

1. A method for predictive modeling comprising:
selecting data samples from a dataset comprising a collection thereof, the data samples including a plurality of independent variables used for collecting the data;
ordering the variables in accordance with their importance based upon preselected criteria; and,
screening the variables;
the above steps being performed using a generalized reduced error logistic regression that utilizes a relatively smaller sample size with a relatively larger number of input variables than other methods of logistic regression with the results from the generalized reduced error logistic regression having a significantly greater reliability and validity than said other methods.

2. The method of claim 1 in which the selection of variables used in choosing the data samples is automated so to reduce dimensional problems in performing the generalized reduced error logistic regression to a manageable size.

3. The method of claim 2 further including computing different solutions corresponding to different alternatives in choice sets, so the generalized reduced error logistic regression is not limited by independence from irrelevant alternative (IIA) restrictions.

4. The method of claim 2 which optimally scales solutions to achieve relatively greater accuracy than results obtained using said other methods.

5. The method of claim 1 which is not biased by the number of non-missing observations in independent variables used in performing the method.

6. The method of claim 1 which allows repeated and multilevel measures designs and more than one dependent variable in performing the method.

7. The method of claim 6 which is used with binomial dependent variables.

8. The method of claim 6 which is used with multinomial dependent variables.

9. The method of claim 6 which is used with ordered or interval-categorized dependent variables.

10. The method of claim 1 in which using generalized reduced error logistic regression is a maximum likelihood based logistic regression that substantially eliminates problems of multicollinearity.

11. The method of claim 10 for providing a probability estimate which is consistent with maximally non-committed Bayesian prior distributions.

12. The method of claim 11 using only the data samples to determine a posteriori distributions, but which is also consistent with Bayesian prior probability weighting should it be warranted.

13. The method of claim 1 wherein the screening of variables includes prescreening the variables to include only the most significant variables for the generalized reduced error logistic regression.

14. The method of claim 1 further including performing successive iterations of the generalized reduced error logistic regression using variable selection and wherein performing the method starts with a relatively large set of variables and gradually reduces this set by deleting the least important variables after every iteration to define what is eventually a best model.

15. The method of claim 3 further including performing multiple generalized reduced error logistic regressions with the regressions being performed using different sets of data samples with each set having a different number of alternatives than the other sets in a multinomial design.

16. The method of claim 15 in which the regressions are performed simultaneously.

17. The method of claim 14 in which the regressions are performed separately.
